(19) United States
(12) Patent Application Publication
(10) Pub. No.: US 2006/0035494 A1
(43) Pub. Date: Feb. 16, 2006

(54) Apparatus for attaching and detaching connectors

(75) Inventors: Kenji Sugaya, Gunma (JP); Seiji Kojima, Gunma (JP)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: Japan Servo Co., Ltd.

(21) Appl. No.: 11/200,409

(22) Filed: Aug. 9, 2005

(30) Foreign Application Priority Data
Aug. 11, 2004 (JP) 234639/2004
Sep. 7, 2004 (JP) 259962/2004
Mar. 17, 2005 (JP) 76572/2005

(51) Int. Cl. H01R 13/62

(52) U.S. Cl. 439/157

(57) ABSTRACT

An apparatus comprises a first member for holding a base part of a first connector and a sealing plug of a second connector, a second member for holding a sealing plug of the first connector and a base part of the second connector, and a stopper. The sealing plug of the first connector and the base part of the second connector are separated from the base part of the first connector and the sealing plug of the second connector respectively. The base part of the second connector and the base part of the first connector are threadedly fastened to each other, and the stopper stops the transfer of the rotation of the first and second gears to the sealing plug of the first connector and the base part of the second connector during the second rotation of the handle.

### BACKGROUND OF THE INVENTION

1. Field of the Invention

This invention relates to an apparatus for attaching and detaching connectors and, more particularly, relates to an apparatus for attaching and detaching connectors for medical use.

2. Description of the Prior Art

In the peritonaeum dialyser, a tube connected to a patient and a tube connected to a dialysis bag are connected through screw type connectors. The attaching and detaching of the connectors must be carried out in a short time positively in order to prevent the connectors from being contaminated with bacteria.

An apparatus for attaching and detaching connectors for medical use has been proposed in the Japanese Patent Application Laid-Open No. 224214/2002, for example.

FIG. 1 is a front view of such conventional apparatus 10 for attaching and detaching connectors, FIG. 2 is a right side view thereof, and FIG. 3 is a plan view thereof with a top cover being removed.

In FIG. 1 to FIG. 3, a reference numeral 1 denotes a housing, 2 denotes a cover, 3 denotes an operation handle, 4 denotes a leg and 5 denotes a suction cap. The housing 1 is positioned on a pedestal and fixed by the suction caps 5 mounted to the legs 4. The apparatus 10 is operated by the rotation of the handle 3.

The apparatus 10 comprises a first member 20 for holding thereon a base part 102 of a first connector on a side of a patient 104 and a sealing plug 203 of a second connector on a side of a dialysis bag 200; a second member 16 for holding thereon a sealing plug 103 of the first connector on the side of the patient 104 and a base part 202 of the second connector on the side of the dialysis bag 200; and a driving device 17 for driving the connectors on the first member 20 and the second member 16, as shown in FIG. 3.

FIG. 4 is a vertically sectional front view of the second member 16 and the driving device 17 for explaining the operations of gears. The operation handle 3 is fixed to a portion of an operation shaft 21 projected from the housing 1.

The second member 16 comprises a gear 38 meshing with first and second gears 24 and 25, gears 36 and 37 meshing with the gear 38, respectively, and first and second drive gears 34 and 35 for rotating the base part 202 of the second connector and the sealing plug 103 of the first connector, respectively on the second member 16.

As shown in FIG. 5A and FIG. 5B, two bevel gears 22-1 and 22-2 separated by a predetermined distance from each other are fixed on an operation shaft 21 rotated by the handle 3, so that gear surfaces thereof are faced to each other. A first gear set composed of a bevel gear 23-1 meshing with the bevel gear 22-1 and the first gear 24 having no toothed portion fixed to the bevel gear 23-1 is supported rotatably by a shaft 40. A second gear set composed of a bevel gear 23-2 meshing with the bevel gear 22-2 and the second gear 25 having no toothed portion fixed to the bevel gear 23-2 is supported rotatably by a shaft 41 arranged in parallel to the shaft 40 and separated by a predetermined distance from the shaft 40. The shafts 40 and 41 are held by a bearing plate 1-2 projected from a base plate 1-1 of the housing 1 so that the first and second gears 24 and 25 are rotated when the handle 3 is operated.

Two guide rods 44 and 45 are arranged so as to extend normally to the operation shaft 21 and separate by a predetermined length from each other. The guide rods 44 and 45 are supported by two holders 42, 43 fixed to the base plate 1-1 of the housing 1. Two slide members 46 and 47 are supported slidably by the holders 42, 43, respectively, and urged in one direction by coil springs 48 and 49. The slide members 46 and 47 are connected by two slide rods 50 and 51 extending in parallel to the operation shaft 21. A slider 31 for holding thereon the first member 20 is held slidably by the slide rods 50 and 51. Abase end of an arm 30 is fixed to a portion of the slider 31 near the base plate 1-1 and a bifurcated portion formed on a tip end portion of the arm 30 is arranged near the operation shaft 21. A bevel gear 27 is fixed to a portion of the operation rod 21 between the bevel gears 22-1 and 22-2. A bevel gear 28 is meshed with the bevel gear 27 and a shaft 60 of the bevel gear 28 is supported rotatably by the base plate 1-1 of the housing 1. A base end of a drive arm 26 is fixed to the shaft 60 and the drive arm 26 has a drive pin 29. The drive pin 29 is engaged slidably with an oval cam 61, and moved along the cam 61 through the drive arm 26 and the bevel gear 27, when the handle 3 is rotated.

As shown in FIG. 4, the first and second drive gears 34 and 35 are provided for rotating the sealing plug 103 of the first connector and the base part 202 of the second connector. Grooves 16-3 are formed on the first and second drive gears 34 and 35, respectively, into which a tube 201 connecting the base part 202 of the second connector with the dialysis 200 is inserted.

FIG. 6 shows a case that the handle 3 is positioned at starting point. In this position, the grooves 16-3 are upright, a toothed portion of the first gear 24 meshes with the gear 38, and no toothed portion of the second gear 25 faces the gear 38, so that the gear 38 is rotated by the first gear 24. The drive pin 29 of the drive arm 26 is positioned at a point A. During the rotation of the handle 3 of about 60 degrees from the starting position in the clockwise direction, the second gear 25 is not meshed with the gear 38, but the first gear 24 meshes with the gear 38, so that the gear 38 is rotated in the counter clockwise direction by the first gear 24, and the first and second drive gears 34 and 35 are rotated in the counter clockwise direction. In a position shown in FIG. 7, the drive pin 29 of the drive arm 26 is positioned at a point B, and the gear 38 faces no toothed portions of the first and second gears 24 and 25, so that the gear 38 is not rotated by the rotation of the handle 3 of about 60 degrees in the clockwise direction.

In a position shown in FIG. 8, the toothed portion of the second gear 25 meshes with the gear 38, and no toothed portion of the first gear 24 faces the 38, so that the gear 38 is rotated by the second gear 25. The drive pin 29 of the drive arm 26 is positioned at point A. During further rotation of the handle 3 of about 60 degrees from the position shown in FIG. 8 in the clockwise direction, the gear 38 is rotated by the second gear 25, so that the gear 38 is rotated in the clockwise direction, and the first and second drive gears 34 and 35 are rotated in the clockwise direction.

During further rotation of the handle 3 of about 60 degrees from the position shown in FIG. 8 in the clockwise direction, the drive pin 29 of the drive arm 26 is positioned at point B, and the gear 38 faces the toothed portion of the first gear 24, so that the gear 38 rotated in the counter clockwise direction, as shown in FIG. 9.

As shown in FIG. 3, the base part 102 of the first connector is mounted on the first member 20, and the sealing plug 103 of the first connector is mounted on a holder to be rotated by the second drive gear 35, on the second member 16. The sealing plug 203 of the second connector is mounted on the connector member 20, and the base part 202 of the second connector is mounted on a holder to be rotated by the first drive gear 34, on the second member 16.

The operation of the apparatus for attaching and detaching of the connectors for use in the peritonaeum dialyser will be explained with reference to FIG. 10 and FIG. 11. As shown in FIG. 10, the base part 102 of the first connector is connected to the patient 104 through a tube 101, and an open end of the base part 102 of the first connector is sealed by the sealing plug 103 of the first connector.

The base part 202 of the second connector is connected to the dialysis bag 200 through the tube 201, and an open end of the base part 202 of the second connector is sealed by the sealing plug 203 of the second connector.

By the rotation of the handle 3 of about 60 degrees from the position shown in FIG. 6 in the clockwise direction, the holders holding the sealing plug 103 of the first connector and the base part 202 of the second connector on the second member 16 are rotated, so that the sealing plug 103 and the base part 202 are threadedly loosed and separated from the base part 102 of the first connector and the sealing plug 203 of the second connector on the first member 20, respectively. By a further rotation of the handle 3 of about 60 degrees in the clockwise direction, the holders on the second member 16 are not rotated, and the first member 20 is moved relative to the second member 16 from a position shown in FIG. 10 to a position shown in FIG. 11, so that the base part 102 of the first connector held by the first member 20 faces the base part 202 of the second connector held by the second member 16, as shown in FIG. 11. By a further rotation of the handle 3 of about 60 degrees, the base part 202 of the second connector held by the second member 16 is rotated and threadedly fastened to the base part 102 of the first connector.

Then, a connected set of the base part 102 of the first connector and the base part 202 of the second connector and a separated set of the sealing plug 103 of the first connector and the sealing plug 203 of the second connector are removed from the first member 20 and the second member 16, respectively.

Finally, the handle 3 is rotated in the clockwise direction and returned to the original position. Specifically, in the position shown in FIG. 9, the drive pin 29 of the drive arm 26 is positioned at the point B. By the rotation of the handle 3 of about 60 degrees in the counter clockwise direction, the drive arm 26 is rotated in the counter clockwise direction by 180 degrees, so that the drive pin 29 of the drive arm 26 is positioned at the point A, as shown in FIG. 8. By a further rotation of the handle 3 of about 60 in the counter clockwise direction, the drive pin 29 is engaged with the bifurcated portion formed on the tip end of the arm 30, and the slider 31 is moved along the oval shaped line, so that the drive pin 29 is positioned at the point B. By next rotation of the handle 3 of the 60 degrees, the drive pin is rotated by 180 degrees and returned to the position of the original point A.

In case that the base part 202 of the second connector is separated from the base part 102 of the first connector, the connected set of the base part 102 of the first connector and the base part 202 of the second connector is mounted on the holders on the first member 20 and the second member 16, and a connected set of a sterilized sealing plug 203 of the second connector and a sterilized sealing plug 103 of the first connector is mounted on the first member 20 and the second member 16, as shown in FIG. 12. By the rotation of the handle 3 of about 60 degrees in the counter clockwise direction, the holders holding the sealing plug 103 of the first connector and the base part 202 of the second connector on the second member 16 are rotated, so that the base part 202 of the second connector is thrededly loosed from the base part 102 of the first connector, and the sterilized sealing plug 203 of the second connector is threadedly loosed from the sterilized sealing plug 103 of the first connector. By a further rotation of the handle 3 of about 60 degrees in the counter clockwise direction, the base part 102 of the first connector is moved relative to the base part 202 of the second connector and faced with the sealing plug 103 of the first connector, as shown in FIG. 13. By a further rotation of the handle 3 of about 60 degrees in the counter clockwise direction, the sealing plug 103 of the first connector is threadedly fastened to the base part 102 of the first connector. The base part 202 of the second connector and the sealing plug 203 of the second connector are removed, and them the handle 3 is returned to the original position.

In the apparatus 10 for attaching and a detaching connectors for medical use, the first member 20 for holding the connector of the patient side and the second member 16 for holding the connector of the dialysis bag side must be removed from the apparatus 10, in order to washing sometimes to keep them clean. However, the first and second drive gears 34 and 35 are moved freely when the second member 16 is removed from the apparatus 10, so that the meshing relation of the original state between the gears 34 and 35 and the gears 38 and the first and second gears 24 and 25 cannot be obtained again when the second member 16 is installed again in the apparatus 10.

The adjustment of the meshing rotation is very difficult and must be spent a long time.

### SUMMARY OF THE INVENTION

An object of the present invention is to solve the above problems.

Another object of the present invention is to provide an apparatus for attaching and detaching connectors comprising a first member for holding a base part of a first connector and a sealing plug of a second connector, a second member for holding a sealing plug of the first connector and a base part of the second connector, a driving device for driving the sealing plug of the first connector and the base part of the second connector, and a stopper, the driving device being composed of an operation shaft to be rotated by a handle, first and second gears each having no toothed portion, rotated in the opposed directions to each other through a gear train by the rotation of the operation shaft, a slider for sliding the first member, relative to the second member through a drive pin moved along a cam by the operation shaft, wherein the sealing plug of the first connector and the base part of the second connector are rotated in one direction on the second member through the first and second gears to separate from the base part of the first connector and the sealing plug of the second connector on the first member, respectively, by a first rotation of the handle of a predetermined angle in the one direction, the first member is moved with respect to the second member through the slider by a second rotation of the handle of a predetermined angle in the one direction so that the base part of the first connector is faced to the base part of the second connector, the base part of the second connector is rotated in the opposite direction on the second member through the first and second gears by a third rotation of the handle of a predetermined angle in the one direction so that the base part of the second connector and the base part of the first connector are threadedly fastened to each other, and the stopper stops the transfer of the rotation of the first and second gears to the sealing plug of the first connector and the base part of the second connector during the second rotation of the handle.

Still another object of the present invention is to provide an apparatus for attaching and detaching connectors comprising a first member for holding a base part of a first connector and a sealing plug of a second connector, a second member for holding a sealing plug of the first connector and a base part of the second connector, a driving device for driving the sealing plug of the first connector and the base part of the second connector, and a stopper, the driving device being composed of an operation shaft to be rotated by a handle, first and second gears each having no toothed portion, rotated in the opposed directions to each other through a gear train by the rotation of the operation shaft, a slider for sliding the first member, relative to the second member through a drive pin moved along a cam by the operation shaft, wherein the sealing plug of the first connector and the base part of the second connector are rotated in one direction on the second member through the first and second gears to separate from the sealing plug of the second connector and the base part of the first connector on the first member, respectively, by a first rotation of the handle of a predetermined angle in the one direction, the first member is moved with respect to the second member through the slider by a second rotation of the handle of a predetermined angle in the one direction so that the base part of the first connector is faced to the sealing plug of the first connector, the sealing plug of the first connector is rotated in the opposite direction on the second member through the first and second gears by a third rotation of the handle of a predetermined angle in the one direction so that the base part of the first connector and the base part of the second connector are threadedly fastened to each other, and the stopper stops the transfer of the rotation of the first and second gears to the sealing plug of the first connector and the base part of the second connector, during the second rotation of the handle.

The stopper comprises an intermediate gear engaging with the first and second gears, cams formed at opposite sides of the circumferential surface of the intermediate gear, and first and second cams fixed to side surfaces of the first and second gears, wherein the cams of the intermediate gear are sliding on the peripheral surfaces of the first and second cams, respectively, and the free rotation of the intermediate gear is stopped.

Further object of the present invention is to provide an apparatus for attaching and detaching connectors comprising a first member for holding a base part of a first connector and a sealing plug of a second connector, a second member for holding a sealing plug of the first connector and a base part of the second connector, a driving device for driving the sealing plug of the first connector and the base part of the second connector, and a stopper, the driving device being composed of an operation shaft to be rotated by a handle, first and second gears each having no toothed portion, rotated in the opposed directions to each other through a gear train by the rotation of the operation shaft, a slider for sliding the first member, relative to the second member through a drive pin moved along a guide cam by the operation shaft, wherein the sealing plug of the first connector and the base part of the second connector are rotated in one direction on the second member through the first and second gears to separate from the base part of the first connector and the sealing plug of the second connector on the first member, respectively, by a first rotation of the handle of a predetermined angle in the one direction, the first member is moved with respect to the second member through the slider by a second rotation of the handle of a predetermined angle in the one direction so that the base part of the first connector is faced to the base part of the second connector, the base part of the second connector is rotated in the opposite direction on the second member through the first and second gears by a third rotation of the handle of a predetermined angle in the one direction so that the base part of the second connector and the base part of the first connector are threadedly fastened to each other, and the stopper stops the motion of the slider at the motion starting point thereof.

Still further object of the present invention is to provide an apparatus for attaching and detaching connectors comprising a first member for holding a base part of a first connector and a sealing plug of a second connector, a second member for holding a sealing plug of the first connector and a base part of the second connector, a driving device for driving the sealing plug of the first connector and the base part of the second connector, and a stopper, the driving device being composed of an operation shaft to be rotated by a handle, first and second gears each having no toothed portion, rotated in the opposed directions to each other through a gear train by the rotation of the operation shaft, a slider for sliding the first member, relative to the second member through a drive pin moved along a guide cam by the operation shaft, wherein the sealing plug of the first connector and the base part of the second connector are rotated in one direction on the second member through the first and second gears to separate from the sealing plug of the second connector and the base part of the first connector on the first member, respectively, by a first rotation of the handle of a predetermined angle in the one direction, the first member is moved with respect to the second member through the slider by a second rotation of the handle of a predetermined angle in the one direction so that the base part of the first connector is faced to the sealing plug of the first connector, the sealing plug of the first connector is rotated in the opposite direction on the second member through the first and second gears by a third rotation of the handle of a predetermined angle in the one direction so that the base part of the first connector and the base part of the second connector are threadedly fastened to each other, and the stopper stops the motion of the slider at the motion starting point thereof.

The stopper comprises lock levers arranged on both sides of the guide cam for engaging with the slider so as to stop the motion of the slider.

Still further object of the present invention is to provide an apparatus for attaching and detaching connectors comprising a first member for holding a base part of a first connector and a sealing plug of a second connector, a second member for holding a sealing plug of the first connector and a base part of the second connector, a driving device for driving the sealing plug of the first connector and the base part of the second connector, and stopping and positioning means, the driving device being composed of an operation shaft to be rotated by a handle, first and second gears each having no toothed portion, rotated in the opposed directions to each other through a gear train by the rotation of the operation shaft, a slider for sliding the first member, relative to the second member through a drive pin moved along a cam by the operation shaft, wherein the sealing plug of the first connector and the base part of the second connector are rotated in one direction on the second member through the first and second gears to separate from the base part of the first connector and the sealing plug of the first connector on the second member, respectively, by a first rotation of the handle of a predetermined angle in the one direction, the first member is moved with respect to the second member through the slider by a second rotation of the handle of a predetermined angle in the one direction so that the base part of the first connector is faced to the base part of the second connector, the base part of the second connector is rotated in the opposite direction on the second member through the first and second gears by a third rotation of the handle of a predetermined angle in the one direction so that the base part of the second connector and the base part of the first connector are threadedly fastened to each other, and the stopping and positioning means stops the transfer of the rotation of the first and second gears to the sealing plug of the first connector and the base part of the second connector and maintains the relative positions of the gears during the second rotation of the handle.

Yet further object of the present invention is to provide an apparatus for attaching and detaching connectors comprising a first member for holding a base part of a first connector and a sealing plug of a second connector, a second member for holding a sealing plug of the first connector and a base part of the second connector, a driving device for driving the sealing plug of the first connector and the base part of the second connector, and stopping and positioning means, the driving device being composed of an operation shaft to be rotated by a handle, first and second gears each having no toothed portion, rotated in the opposed directions to each other through a gear train by the rotation of the operation shaft, a slider for sliding the first member, relative to the second member through a drive pin moved along a cam by the operation shaft, wherein the sealing plug of the first connector and the base part of the second connector are rotated in one direction on the second member through the first and second gears to separate from the sealing plug of the second connector and the base part of the first connector on the first member, respectively, by a first rotation of the handle of a predetermined angle in the one direction, the first member is moved with respect to the second member through the slider by a second rotation of the handle of a predetermined angle in the one direction so that the base part of the first connector is faced to the sealing plug of the first connector, the sealing plug of the first connector is rotated in the opposite direction on the second member through the first and second gears by a third rotation of the handle of a predetermined angle in the one direction so that the base part of the second connector and the base part of the first connector are threadedly fastened to each other, and the stopping and positioning means stops the transfer of the rotation of the first and second gears to the sealing plug of the first connector and the base part of the second connector and maintains the relative positions of the gears during the second rotation of the handle.

The stopping and positioning means comprises an intermediate gear engaging with the first and second gears, cams formed at opposite sides of the circumferential surface of the intermediate gear, first and second cams fixed to side surfaces of the first and second gears, a third cam having a notched portion fixed to a shaft of the intermediate gear, and a plunger mounted on the bearing plate at an end point of rotation of the handle so as to slidably contact with the third cam, wherein the cams of the intermediate gear are sliding on the peripheral surfaces of the first and second cams, respectively, the free rotation of the intermediate gear is stopped, and a tip end of the plunger engages with the notched portion of the cam, so that the rotation of the intermediate gear is stopped positively, even if there is a large backlash of the gear or a clearance between the cams.

These and other aspects and objects of the present invention will be better appreciate and understood when considered in conjunction with the following description and the accompanying drawings. It should be understood, however, that the following description, while indication preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a front view of a conventional apparatus for attaching and detaching connectors.

FIG. 2 is a right side view of the apparatus shown in FIG. 1.

FIG. 3 is a plan view of the apparatus shown in FIG. 1 with a top cover being removed.

FIG. 4 is a vertically sectional back view of the apparatus shown in FIG. 1.

FIG. 5A is a plan view of a lower part of the apparatus shown in FIG. 1.

FIG. 5B is a vertically sectional side view of the apparatus shown in FIG. 1.

FIG. 6 is a view for explaining the movement of the apparatus shown in FIG. 1.

FIG. 7 is a view for explaining the movement of the apparatus shown in FIG. 1.

FIG. 8 is a view for explaining the movement of the apparatus shown in FIG. 1.

FIG. 9 is a view for explaining the movement of the apparatus shown in FIG. 1.

FIG. 10 is a view for explaining the attaching and detaching operations of the apparatus shown in FIG. 1.

FIG. 11 is a view for explaining the attaching and detaching operations of the apparatus shown in FIG. 1.

FIG. 12 is a view for explaining the attaching and detaching operations of the apparatus shown in FIG. 1.

FIG. 13 is a view for explaining the attaching and detaching operations of the apparatus shown in FIG. 1.

FIG. 14 is a back view of an essential portion of an apparatus according to the present invention.

FIG. 15 is a plan view of a lower part of the apparatus shown in FIG. 14.

FIG. 16 is a view explaining an essential portion of the apparatus according to the present invention.

FIG. 17 is a view explaining an essential portion of the apparatus according to the present invention.

FIG. 18 is a view explaining an essential portion of the apparatus according to the present invention.

FIG. 19 is a view explaining an essential portion of the apparatus according to the present invention.

FIG. 20 is a view explaining an essential portion of the apparatus according to the present invention.

FIG. 21 is a view explaining an essential portion of the apparatus according to the present invention.

FIG. 22 is a view explaining an essential portion of the apparatus according to the present invention.

FIG. 23 is a view explaining an essential portion of the apparatus according to the present invention.

FIG. 24 is a plan view of a lower part of an apparatus according to another embodiment of the present invention.

FIG. 25 is a view explaining the operation of the apparatus shown in FIG. 24.

FIG. 26 is a view explaining the operation of the apparatus shown in FIG. 24.

FIG. 27 is a view explaining the operation of the apparatus shown in FIG. 24.

FIG. 28 is a view explaining the operation of the apparatus shown in FIG. 24.

FIG. 29 is a back view of an essential portion of an apparatus according to the other embodiment of the present invention.

FIG. 30 is a plan view of a lower part of the apparatus shown in FIG. 29.

FIG. 31 is a view explaining an essential portion of the apparatus shown in FIG. 29.

FIG. 32 is a view explaining an essential portion of the apparatus shown in FIG. 29.

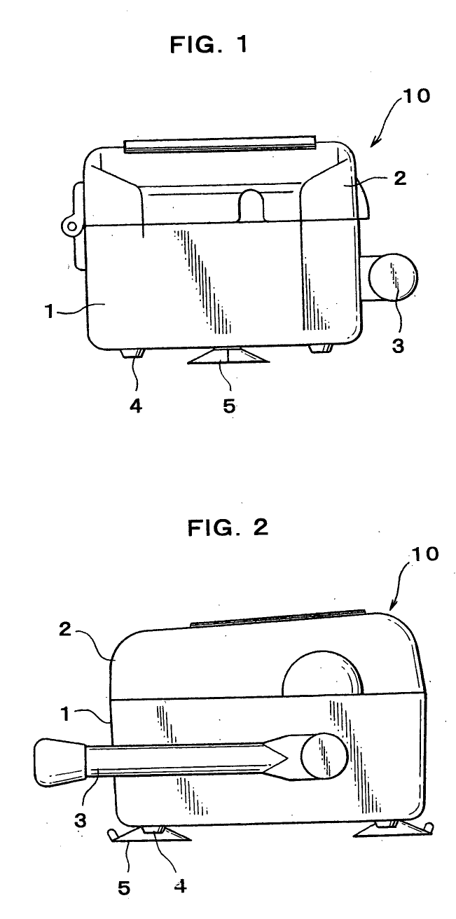

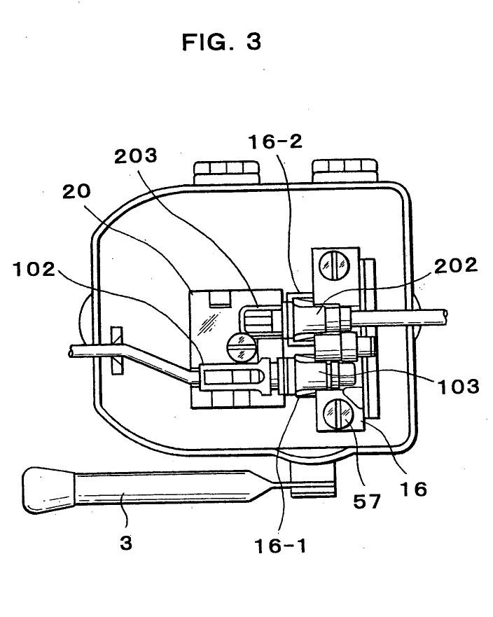

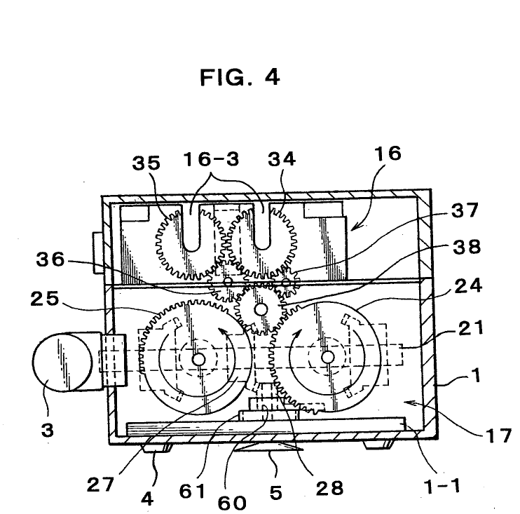

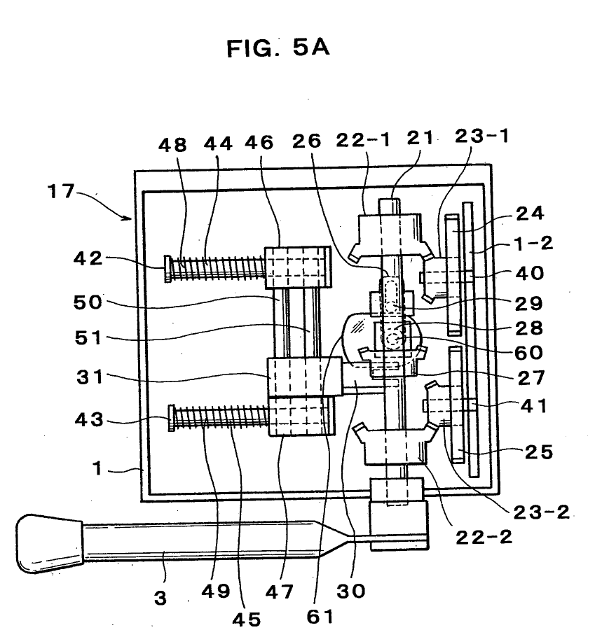

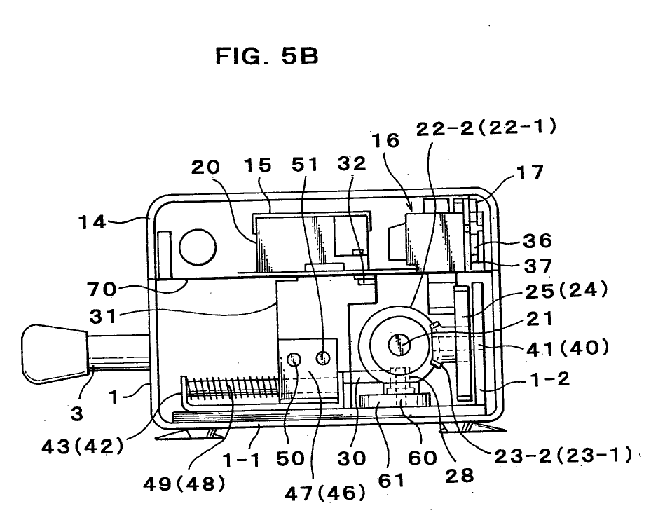

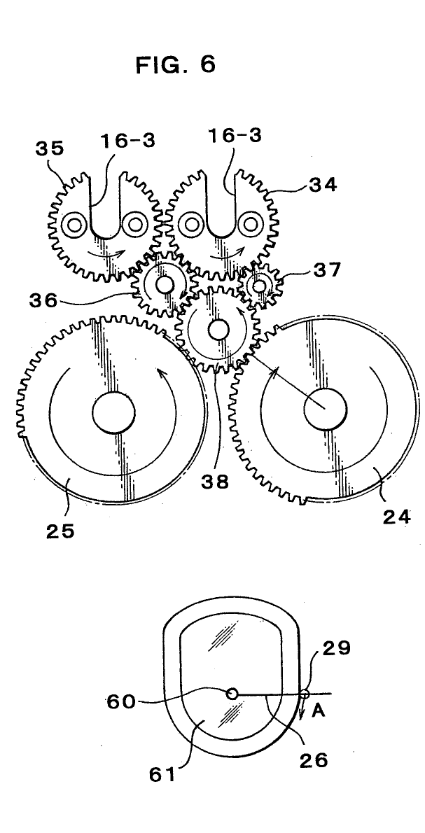

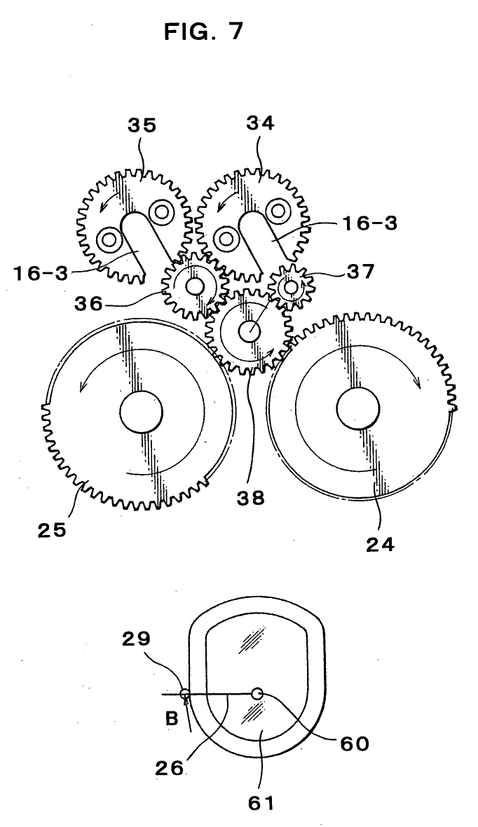

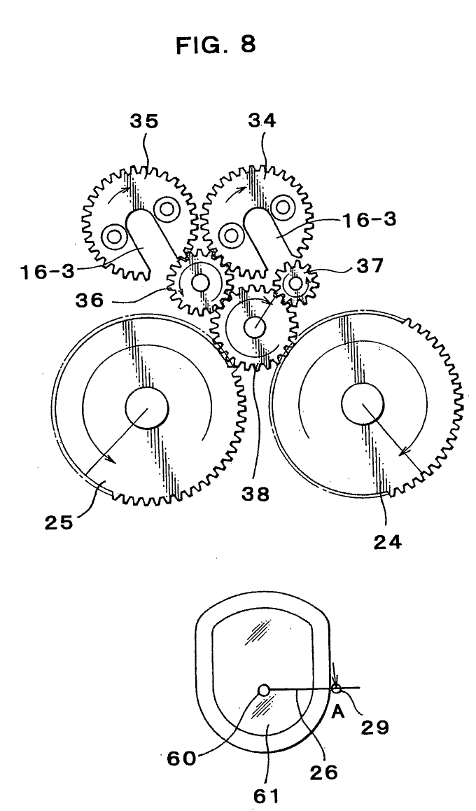

### DESCRIPTION OF THE PREFERRED EMBODIMENT

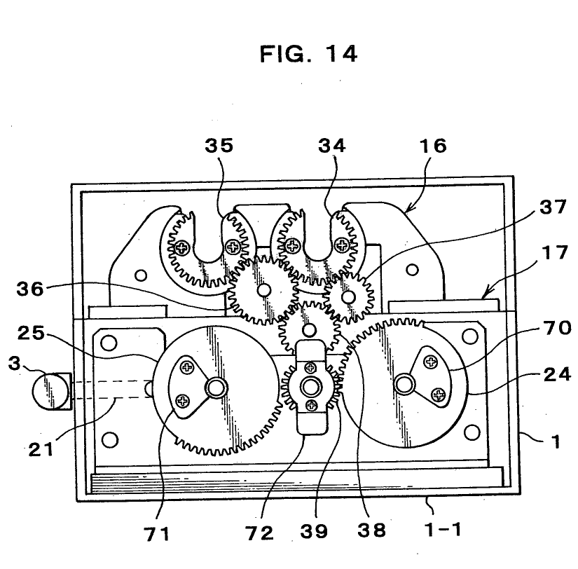

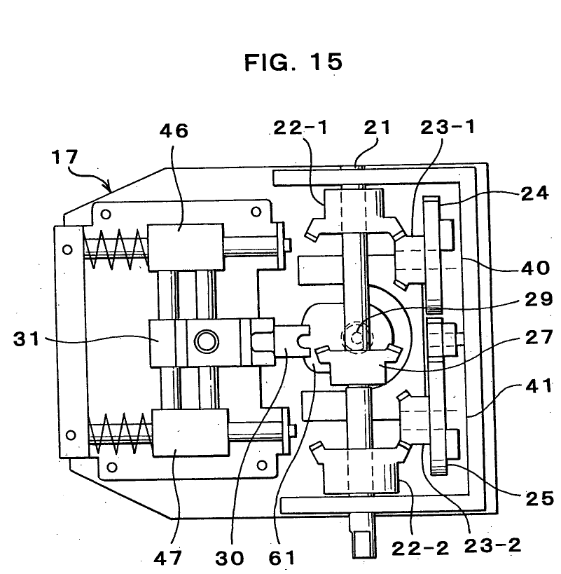

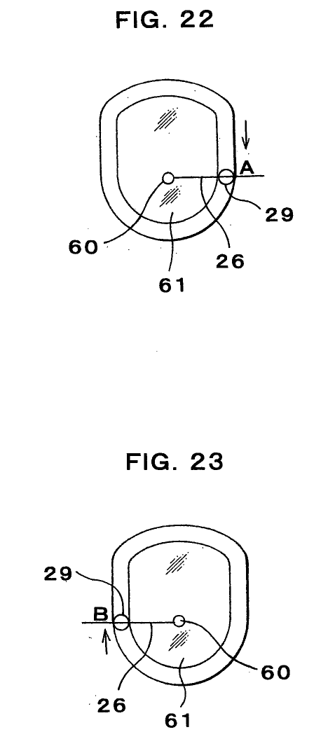

A first embodiment of the present invention will now be explained with reference to FIG. 14 to FIG. 23.

As shown in FIG. 14 to FIG. 16, in the first embodiment of the present invention, the second member 16 comprises a gear 39 having cams 72 at opposite sides of the circumferential surface thereof, meshing with the first and second gears 24 and 25, the gear 38 meshing with the gear 39, and the gears 36 and 37 meshing with the gear 38, respectively, and the first and second drive gears 34 and 35 for rotating on the second member 16 the base part 202 of the second connector and the sealing plug 103 of the first connector, respectively.

A gear set composed of the bevel gear 23-1 meshing with the bevel gear 22-1, the first gear 24 having no toothed portion fixed to the bevel gear 23-1 and a first cam 70 fixed to side surface of the first gear 24 is supported rotatably by the shaft 40. A gear set composed of the bevel gear 23-2 meshing with the bevel gear 22-2, the second gear 25 having no toothed portion fixed to the bevel gear 23-2 and a second cam 71 fixed to side surface of the second gear 25 is supported rotatably by the shaft 41 arranged in parallel to the shaft 40 and separated by a predetermined distance from the shaft 40. The shafts 40 and 41 are held by the bearing plate 1-2 projected from the base plate 1-1 of the housing 1 so that the first and second gears 24 and 25 are rotated when the handle 3 is operated.

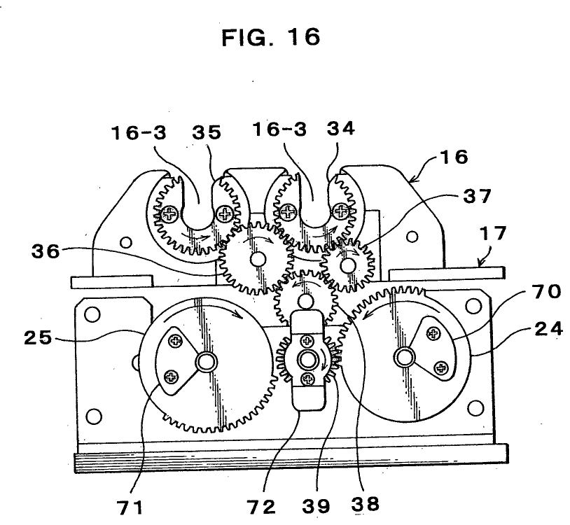

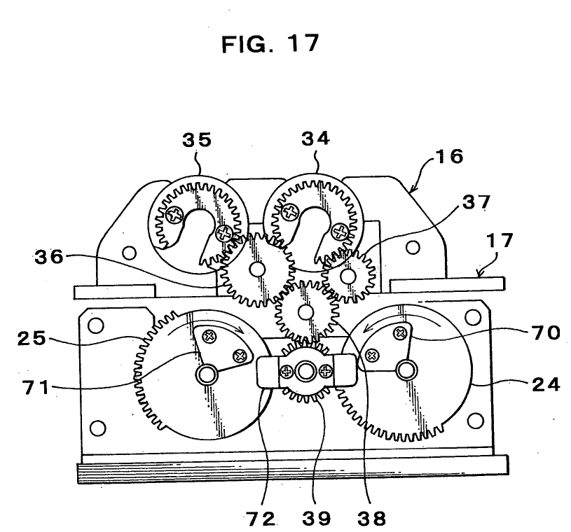

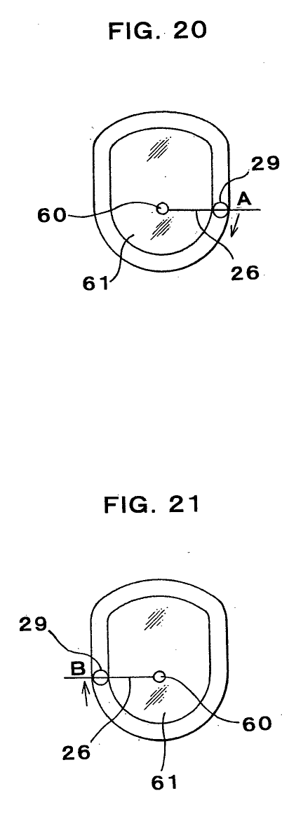

FIG. 14 and FIG. 16 show a case that the handle 3 is positioned at starting point. In this position, the grooves 16-3 are upright, the toothed portion of the first gear 24 meshes with the gear 39, and the no toothed portion of the second gear 25 faces the gear 39, so that the gear 39 is rotated by the first gear 24. The drive pin 29 of the drive arm 26 is positioned at the point A, as shown in FIG. 20. During the rotation of the handle 3 of about 60 degrees from the starting position in the clockwise direction, the second gear 25 is not meshed with the gear 39, but the first gear 24 meshes with the gear 39, so that the gear 39 is rotated in the clockwise direction by the first gear 24, and the first and second drive gears 34 and 35 are rotated in the counter clockwise direction. In a position shown in FIG. 17 and FIG. 21, the drive pin 29 of the drive arm 26 is positioned at the point B, and the gear 39 faces no toothed portions of the first and second gears 24 and 25, so that the gear 39 is not rotated by the further rotation of the handle 3 of about 60 degrees in the clockwise direction.

In the position shown in FIG. 17 and FIG. 21, the cams 72 of the gear 39 slide on the peripheral surfaces of the cams 70 and 71 of the first and second gears 24 and 25, respectively. During the rotation of the handle 3 of about 60 degrees from the position shown in FIG. 17 in the clockwise direction, the gear 39 cannot be rotated freely because the cams 72 of the gear 39 engage with the peripheral surfaces of the cams 70 and 71 of the first and second gears 24 and 25, respectively.

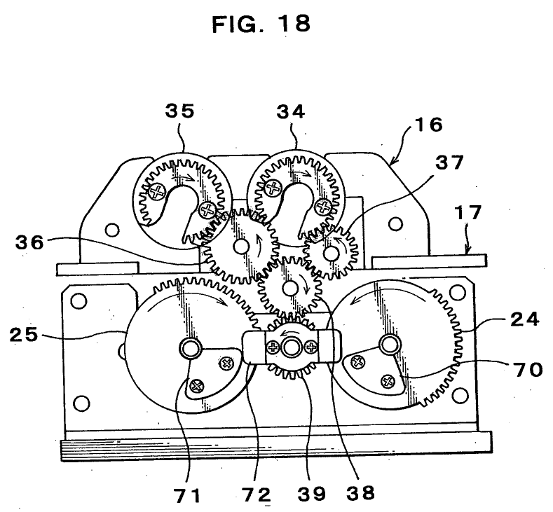

During a further rotation of the handle 3 of about 60 degrees from the position shown in FIG. 18 in the clockwise direction, the cams 72 of the gear 39 are disengaged from the peripheral surfaces of the cams 70 and 71, and the gear 39 is rotated by the second gear 25, so that the gear 39 is rotated in the counter clockwise direction, and the first and second drive gears 34 and 35 are rotated in the clockwise direction. The drive pin 29 of the drive arm 26 is positioned at the point B, as shown in FIG. 23.

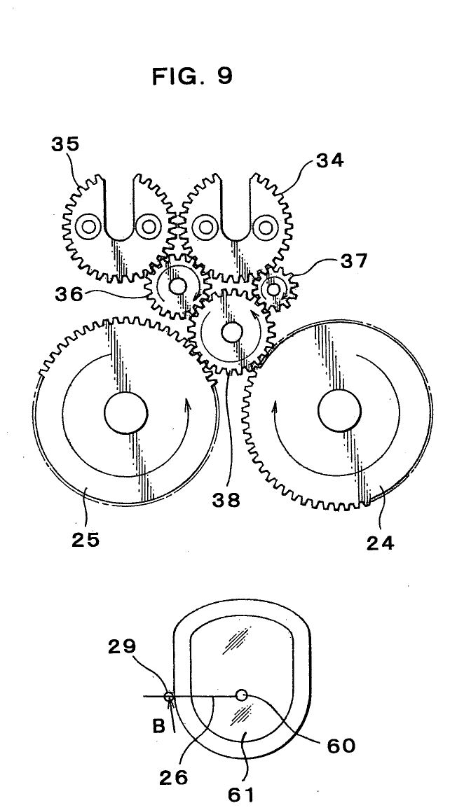

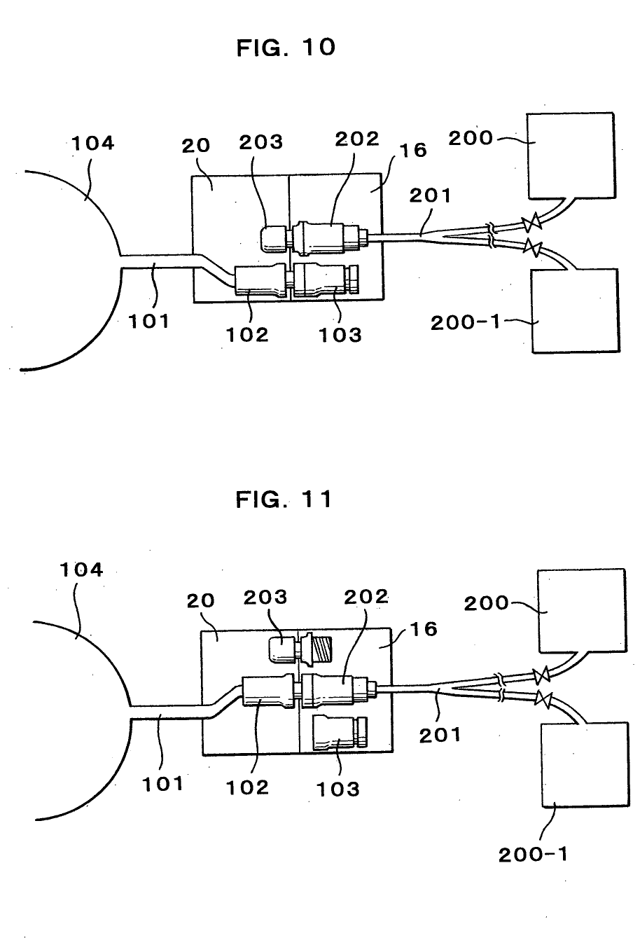

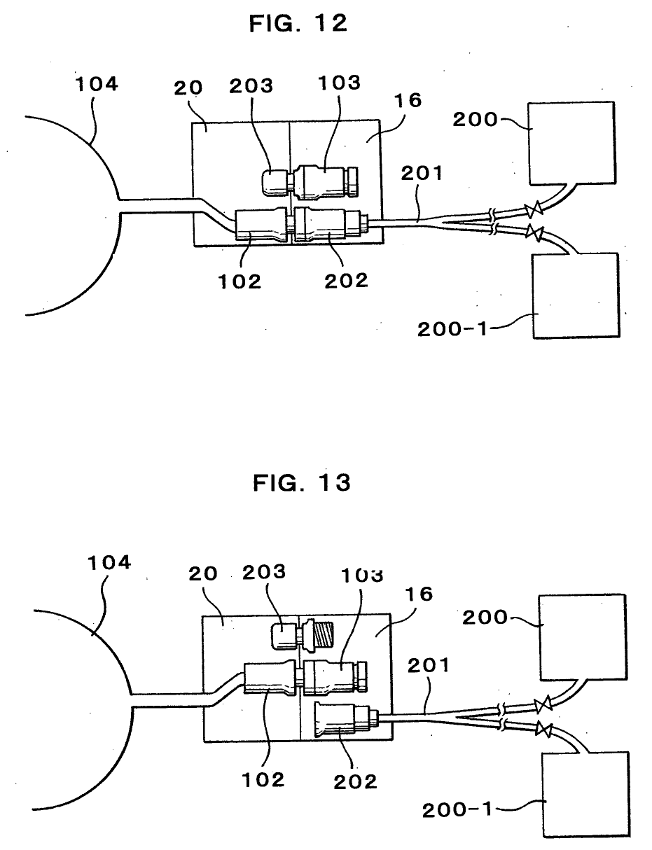

In the apparatus for attaching and detaching of the connectors according to the present invention, by the first rotation of the handle 3 of about 60 degrees from the position shown in FIG. 16 in the clockwise direction, the holders holding the sealing plug 103 of the first connector and the base part 202 of the second connector on the second member 16 are rotated, so that the sealing plug 103 and the base part 202 are threadedly loosed and separated from the base part 102 of the first connector and the sealing plug 203 of the second connector on the first member 20, respectively. By the second rotation of the handle 3 of about 60 degrees in the clockwise direction, the holders on the second member 16 are not rotated, and the first member 20 is moved relative to the second member 16 from the position shown in FIG. 10 to the position shown in FIG. 11, so that the base part 102 of the first connector held by the first member 20 faces the base part 202 of the second connector held by the second member 16, as shown in FIG. 11. By the third rotation of the handle 3 of about 60 degrees, the base part 202 of the second connector held by the second member 16 is rotated and threadedly fastened to the base part 102 of the first connector.

Finally, the handle 3 is rotated in the clockwise direction and returned to the original position.

According to this embodiment of the present invention, during the second rotation of the arm 3, the meshing relation between the first and second drive gears 34 and 35 and the gear 38 can be fixed by the gear 39 which is stopped the rotation during the cams 72 of the gear 39 are engaged with the peripheral surfaces of the cams 70 and 71 fixed to the first and second gears 24 and 25.

A second embodiment of the present invention will be explained with reference to FIG. 16 to FIG. 19 and FIG. 24 to FIG. 28.

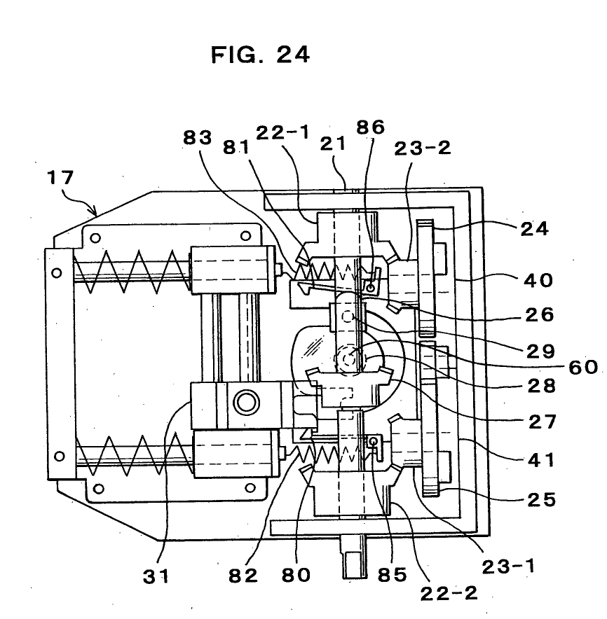

In the second embodiment, as shown in FIG. 24 and FIG. 25, the bevel gear 28 is meshed with the bevel gear 27 and the shaft 60 of the bevel gear 28 is supported rotatably by base plate 1-1 of the housing 1. The base end of the drive arm 26 is fixed to the shaft 60 and the free end of the drive arm 26 has the drive pin 29. The drive pin 29 is engaged slidably with the oval cam 61, and moved along the cam 61 through the drive arm 26, when the handle 3 is rotated.

Lock levers 80 and 81 are arranged on both sides of the oval cam 61 and rotatably supported by shafts 85 and 86 on the housing 1 and engaged with the slider 31 for holding the first member 20. The lock levers 80 and 81 are urged by springs 82 and 83 so as to engage with the slider 31, respectively.

FIG. 16 and FIG. 25 shows a case that the handle 3 is positioned at starting point. In this position, the grooves 16-3 are upright, the toothed portion of the first gear 24 meshes with the gear 39, and no toothed portion of the second gear 25 faces the gear 39, so that the gear 39 is rotated by the first gear 24. The drive pin 29 of the drive arm 26 is positioned at the point A.

In this state, the lock lever 81 is urged by the drive arm 26, so that the lock lever 81 cannot be engaged with the slider 31, whereas the lock lever 80 is engaged with the slider 31 through a hook portion of the lock lever 80 by the spring action of the spring 82, so that the slider 31 is stopped.

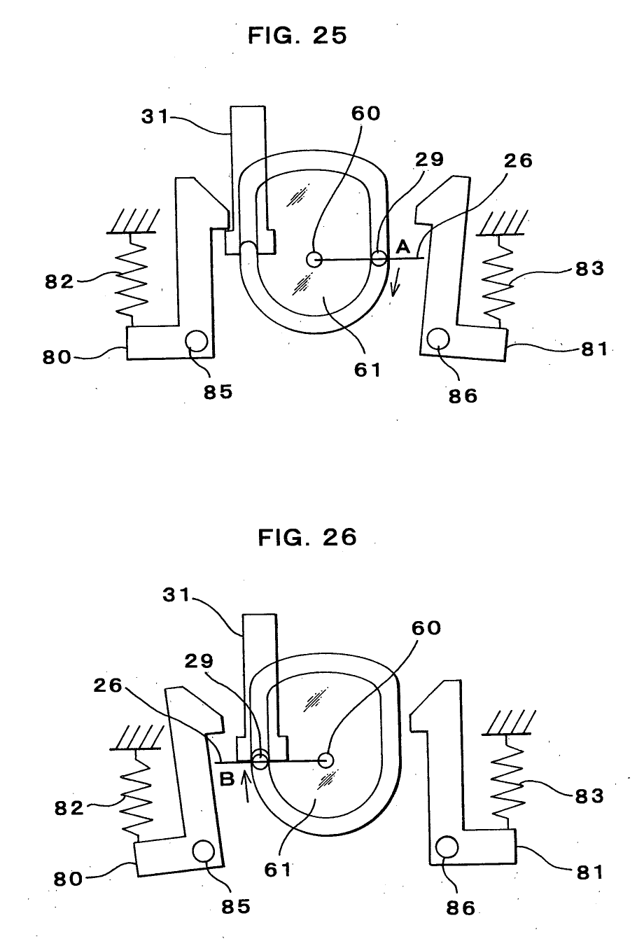

When the handle 3 is rotated by about 60 degrees from the position shown in FIG. 16 and FIG. 25, the second gear 25 is not meshed with the gear 39, but the first gear 24 meshes with the gear 39, so that the gear 39 is rotated in the clockwise direction by the first gear 24, and the first and second drive gears 34 and 35 are rotated in the counter clockwise direction. In a position shown in FIG. 17 and FIG. 26, the drive pin 29 of the drive arm 26 is positioned at the point B, and the gear 39 faces no toothed portions of the first and second gears 24 and 25, so that the gear 39 is not rotated by the further rotation of the handle 3 of about 60 degrees in the clockwise direction.

In the position shown in FIG. 17 and FIG. 26, the cams 72 of the gear 39 slide on the peripheral surfaces of the cams 70 and 71 of the first and second gears 24 and 25, respectively, and the lock lever 80 is urged by the drive arm 26 and disengaged from the slider 31, so that the slider 31 can be moved freely.

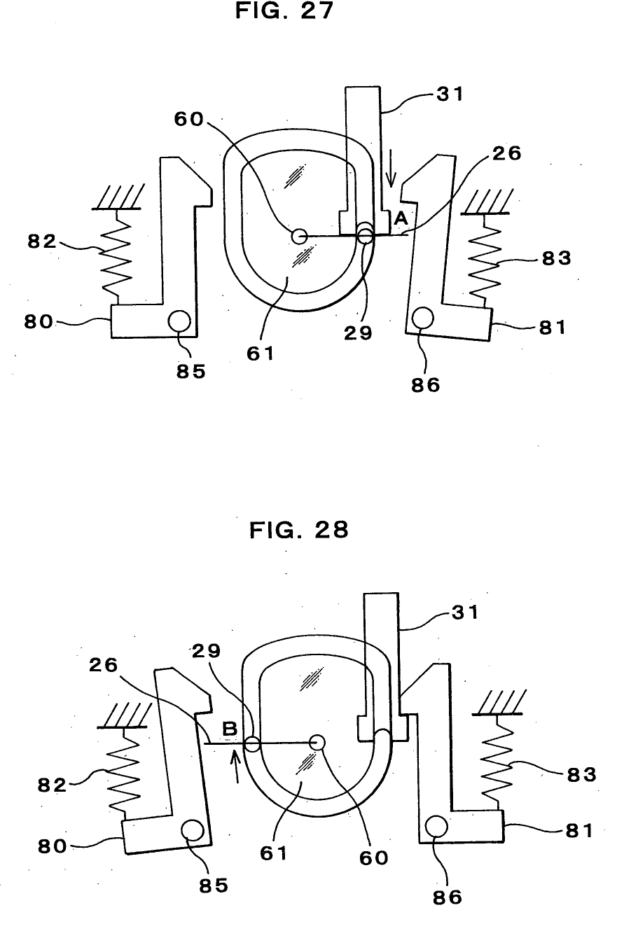

In a position shown in FIG. 18 and FIG. 27, the toothed portion of the second gear 25 meshes with the gear 39, and no toothed portion of the first gear 24 faces the gear 39, so that the gear 39 is rotated by the second gear 25. The drive pin 29 of the drive arm 26 is positioned at the point A, as shown in FIG. 27. During the rotation of the handle 3 of about 60 degrees from the position shown in FIG. 17 and FIG. 27 in the clockwise direction, the gear 39 cannot be rotated freely because the cams 72 of the gear 39 engage with the peripheral surfaces of the cams 70 and 71 of the first and second gears 24 and 25, respectively.

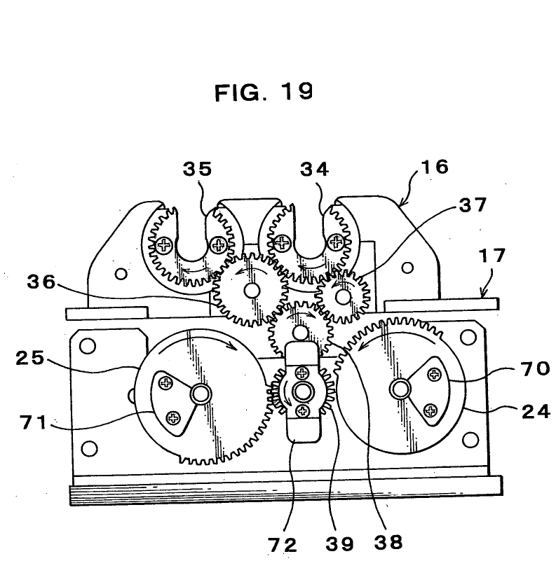

During a further rotation of the handle 3 of about 60 degrees from the position shown in FIG. 18 and FIG. 27 in the clockwise direction, the cams 72 of the gear 39 are disengaged from the peripheral surfaces of the cams 70 and 71, and the gear 39 is rotated by the second gear 25, so that the gear 39 is rotated in the counter clockwise direction, and the first and second drive gears 34 and 35 are rotated in the clockwise direction as shown in FIG. 19. The drive pin 29 of the drive arm 26 is positioned at point B, as shown in FIG. 28, and the gear 39 faces the toothed portion of the second gear 25, so that the gear 39 is rotated in the counter clockwise direction.

In the position shown in FIG. 19 and FIG. 28, the slider 31 is lowered passing through the lock lever 81 and engaged with the lock lever 81, so that the slider 31 is stopped.

According to this embodiment of the present invention, by the first rotation of the handle 3 of about 60 degrees from the position shown in FIG. 16 in the clockwise direction, the holders holding the sealing plug 103 of the first connector and the base part 202 of the second connector on the second member 16 are rotated, so that the sealing plug 103 and the base part 202 are threadedly loosed and separated from the base part 102 of the first connector and the sealing plug 203 of the second connector on the first member 20, respectively. By the second rotation of the handle 3 of about 60 degrees in the clockwise direction, the holders on the second member 16 are not rotated, and the first member 20 is moved relative to the second member 16 from the position shown in FIG. 10 to the position shown in FIG. 11, so that the base part 102 of the first connector held by the first member 20 faces the base part 202 of the second connector held by the second member 16, as shown in FIG. 11. By the third rotation of the handle 3 of about 60 degrees, the base part 202 of the second connector held by the second member 16 is rotated and threadedly fastened to the base part 102 of the first connector.

Finally, the handle 3 is rotated in the clockwise direction and returned to the original position.

According to this embodiment of the present invention, during the second rotation of the arm 3, the meshing relation between the first and second drive gears 34 and 35 and the gear 38 can be fixed by the gear 39 which is stopped the rotation during the cams 72 of the gear 39 are engaged with the peripheral surfaces of the cams 70 and 71 fixed to the first and second gears 24 and 25. Further, the slider 31 is stooped by the lock levers 80 and 81 and not moved freely, during the rotation of the handle 3 of the first rotation and the third rotation.

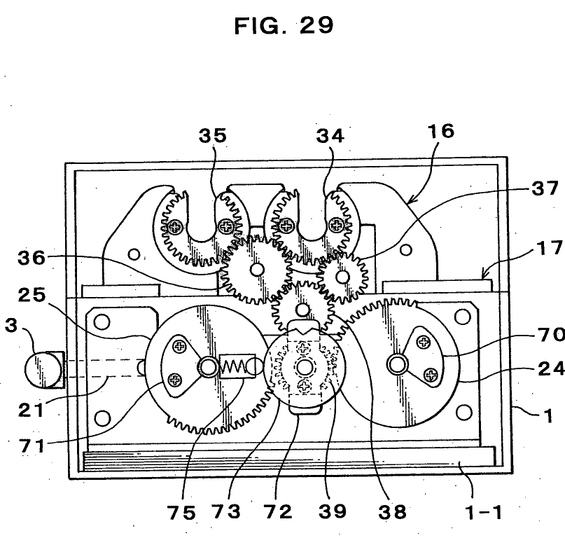

A third embodiment of the present invention will be explained with reference to FIG. 29 to FIG. 32.

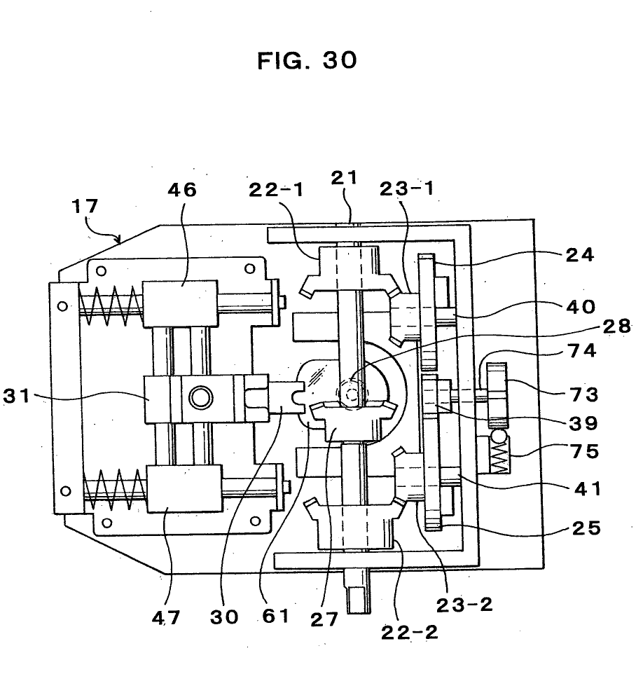

In the third embodiment, as shown in FIG. 29 and FIG. 30, a cam 73 having a notched portion is fixed to a shaft 74 of the gear 39 which is rotated through the first and second gears 24 and 26 by the handle 3, and a plunger 75 is mounted on the bearing plate 1-2 at an end point of rotation of the handle 3 so as to slidably contact with the cam 73.

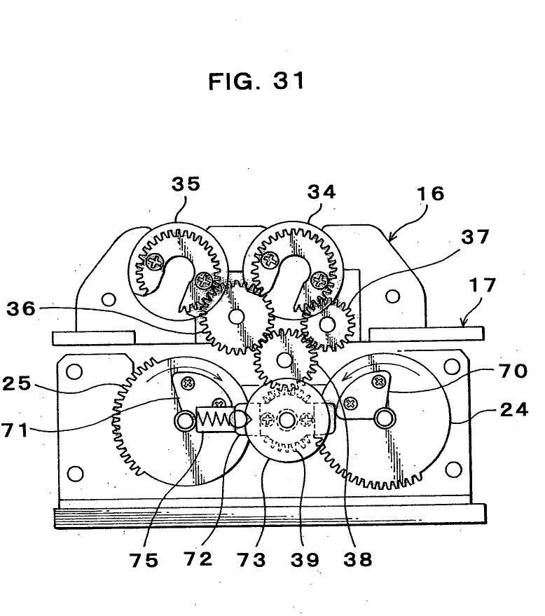

In a position shown in FIG. 31, the gear 39 faces no toothed portions of the first and second gears 24 and 25, so that the gear 39 is not rotated by the rotation of the handle 3 of about 60 degrees in the clockwise direction. By a further rotation of the handle 3 from the position shown in FIG. 31, the cams 72 of the gear 39 slide on the peripheral surfaces of the cams 70 and 71 of the first and second gears 24 and 25, respectively, and a tip end of the plunger 75 engages with the notched portion of the cam 73, so that the rotation of the gear 39 is stopped positively, even if there is a large backlash of the gear or a clearance between the cams 71 and 72.

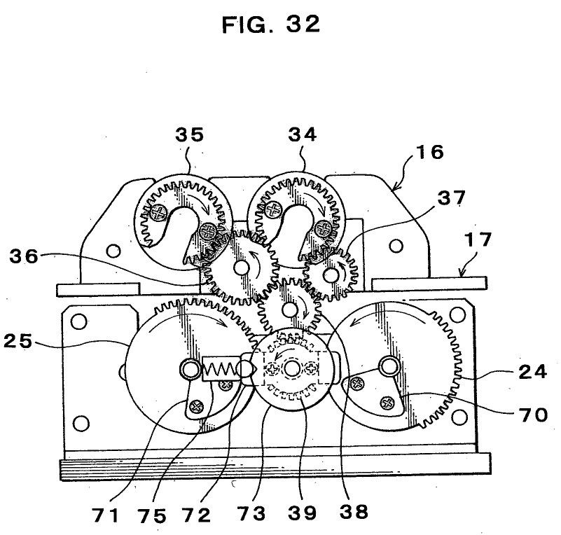

In a position shown in FIG. 32, the toothed portion of the second gear 25 meshes with the gear 39, and no toothed portion of the first gear 24 faces the gear 39, so that the gear 39 is rotated by the second gear 25. During the rotation of the handle 3 of about 60 degrees from the position shown in FIG. 31 in the clockwise direction, the gear 39 cannot be rotated freely because the cams 72 of the gear 39 engage with the peripheral surfaces of the cams 70 and 71 of the first and second gears 24 and 25, respectively, and the tip end of the plunger 75 engages with the notched portion of the cam 73, so that the rotation of the gear 39 is stopped.

The engagements of the cams 70, 71, 72 and 73 and the plunger 75 are released when the toothed portion of the second gear 25 is positioned so as to face to the gear 39.

During a further rotation of the handle 3 of about 60 degrees from the position shown in FIG. 32 in the clockwise direction, gear 39 is rotated in the counter clockwise direction, and the first and second drive gears 34 and 35 are rotated in the clockwise direction.

In the apparatus for attaching and detaching of the connectors according to this embodiment of the present invention, by the first rotation of the handle 3 of about 60 degrees from the position shown in FIG. 29 in the clockwise direction, the holders holding the sealing plug 103 of the first connector and the base part 202 of the second connector on the second member 16 are rotated, so that the sealing plug 103 and the base part 202 are threadedly loosed and separated from the base part 102 of the first connector and the sealing plug 203 of the second connector on the first member 20, respectively. By the second rotation of the handle 3 of about 60 degrees in the clockwise direction, the holders on the second member 16 are not rotated, and the first member 20 is moved relative to the second member 16, so that the base part 102 of the first connector held by the first member 20 faces the base part 202 of the second connector held by the second member 16. By the third rotation of the handle 3 of about 60 degrees, the base part 202 of the second connector held by the second member 16 is rotated and threadedly fastened to the base part 102 of the first connector. Finally, the handle 3 is rotated in the clockwise direction and returned to the original position.

The rotation of the handle 3 of about 60 degrees can be changed to an arbitrary angle.

The operation shaft 21 can be rotated by an electric motor, for example, and the apparatus for attaching and detaching connectors can be used for the physical and chemical equipment, the industrial equipment, or the like.

As stated above, according to the apparatus of the present invention, the first and second connectors can be attached and detached simply by an operation of the handle without contacting with the hand to the open end of the connector. Further, the relation between the gears of the apparatus can be kept positively by the cam arrangement.

While this invention has been described with specific embodiments thereof, it is evident that many alternatives, modifications, and variations will be apparent to those skilled in the art. Accordingly, the preferred embodiments of the invention as set forth herein are intended to be illustrative, not limiting. Various changes may be made without departing from the spirit and scope of the invention. The scope of the present invention should be defined by the terms of the claims appended hereto.

We claim:

1. An apparatus for attaching and detaching connectors comprising:
a first member for holding a base part of a first connector and a sealing plug of a second connector,
a second member for holding a sealing plug of the first connector and a base part of the second connector, a driving device for driving the sealing plug of the first connector and the base part of the second connector, and
a stopper,
the driving device being composed of an operation shaft to be rotated by a handle, first and second gears each having no toothed portion, rotated in the opposed directions to each other through a gear train by the rotation of the operation shaft, a slider for sliding the first member, relative to the second member through a drive pin moved along a cam by the operation shaft, wherein the sealing plug of the first connector and the base part of the second connector are rotated in one direction on the second member through the first and second gears to separate from the base part of the first connector and the sealing plug of the second connector on the first member, respectively, by a first rotation of the handle of a predetermined angle in the one direction, the first member is moved with respect to the second member through the slider by a second rotation of the handle of a predetermined angle in the one direction so that the base part of the first connector is faced to the base part of the second connector, the base part of the second connector is rotated in the opposite direction on the second member through the first and second gears by a third rotation of the handle of a predetermined angle in the one direction so that the base part of the second connector and the base part of the first connector are threadedly fastened to each other, and the stopper stops the transfer of the rotation of the first and second gears to the sealing plug of the first connector and the base part of the second connector during the second rotation of the handle.

2. The apparatus as claimed in claim 1, wherein the stopper comprises an intermediate gear engaging with the first and second gears, cams formed at opposite sides of the circumferential surface of the intermediate gear, and first and second cams fixed to side surfaces of the first and second gears, wherein the cams of the intermediate gear are sliding on the peripheral surfaces of the first and second cams, respectively, and the free rotation of the intermediate gear is stopped

3. An apparatus for attaching and detaching connectors comprising:
a first member for holding a base part of a first connector and a sealing plug of a second connector,
a second member for holding a sealing plug of the first connector and a base part of the second connector,
a driving device for driving the sealing plug of the first connector and the base part of the second connector, and
a stopper,
the driving device being composed of an operation shaft to be rotated by a handle, first and second gears each having no toothed portion, rotated in the opposed directions to each other through a gear train by the rotation of the operation shaft, a slider for sliding the first member, relative to the second member through a drive pin moved along a cam by the operation shaft, wherein the sealing plug of the first connector and the base part of the second connector are rotated in one direction on the second member through the first and second gears to separate from the sealing plug of the second connector and the base part of the first connector on the first member, respectively, by a first rotation of the handle of a predetermined angle in the one direction, the first member is moved with respect to the second member through the slider by a second rotation of the handle of a predetermined angle in the one direction so that the base part of the first connector is faced to the sealing plug of the first connector, the sealing plug of the first connector is rotated in the opposite direction on the second member through the first and second gears by a third rotation of the handle of a predetermined angle in the one direction so that the base part of the first connector and the base part of the second connector are threadedly fastened to each other, and the stopper stops the transfer of the rotation of the first and second gears to the sealing plug of the first connector and the base part of the second connector, during the second rotation of the handle.

4. The apparatus as claimed in claim 3, wherein the stopper comprises an intermediate gear engaging with the first and second gears, cams formed at opposite sides of the circumferential surface of the intermediate gear, and first and second cams fixed to side surfaces of the first and second gears, wherein the cams of the intermediate gear are sliding on the peripheral surfaces of the first and second cams, respectively, and the free rotation of the intermediate gear is stopped.

5. An apparatus for attaching and detaching connectors comprising:
a first member for holding a base part of a first connector and a sealing plug of a second connector,
a second member for holding a sealing plug of the first connector and a base part of the second connector,
a driving device for driving the sealing plug of the first connector and the base part of the second connector, and
a stopper,
the driving device being composed of an operation shaft to be rotated by a handle, first and second gears each having no toothed portion, rotated in the opposed directions to each other through a gear train by the rotation of the operation shaft, a slider for sliding the first member, relative to the second member through a drive pin moved along a guide cam by the operation shaft, wherein the sealing plug of the first connector and the base part of the second connector are rotated in one direction on the second member through the first and second gears to separate from the base part of the first connector and the sealing plug of the second connector on the first member, respectively, by a first rotation of the handle of a predetermined angle in the one direction, the first member is moved with respect to the second member through the slider by a second rotation of the handle of a predetermined angle in the one direction so that the base part of the first connector is faced to the base part of the second connector, the base part of the second connector is rotated in the opposite direction on the second member through the first and second gears by a third rotation of the handle of a predetermined angle in the one direction so that the base part of the second connector and the base part of the first connector are threadedly fastened to each other, and the stopper stops the motion of the slider at the motion starting point thereof.

6. The apparatus as claimed in claim 5, wherein the stopper comprises lock levers arranged on both sides of the guide cam for engaging with the slider so as to stop the motion of the slider.

7. An apparatus for attaching and detaching connectors comprising:
a first member for holding a base part of a first connector and a sealing plug of a second connector,
a second member for holding a sealing plug of the first connector and a base part of the second connector,
a driving device for driving the sealing plug of the first connector and the base part of the second connector, and
a stopper,
the driving device being composed of an operation shaft to be rotated by a handle, first and second gears each having no toothed portion, rotated in the opposed directions to each other through a gear train by the rotation of the operation shaft, a slider for sliding the first member, relative to the second member through a drive pin moved along a guide cam by the operation shaft, wherein the sealing plug of the first connector and the base part of the second connector are rotated in one direction on the second member through the first and second gears to separate from the sealing plug of the second connector and the base part of the first connector on the first member, respectively, by a first rotation of the handle of a predetermined angle in the one direction, the first member is moved with respect to the second member through the slider by a second rotation of the handle of a predetermined angle in the one direction so that the base part of the first connector is faced to the sealing plug of the first connector, the sealing plug of the first connector is rotated in the opposite direction on the second member through the first and second gears by a third rotation of the handle of a predetermined angle in the one direction so that the base part of the first connector and the base part of the second connector are threadedly fastened to each other, and the stopper stops the motion of the slider at the motion starting point thereof.

8. The apparatus as claimed in claim 7, wherein the stopper comprises lock levers arranged on both sides of the guide cam for engaging with the slider so as to stop the motion of the slider.

9. An apparatus for attaching and detaching connectors comprising:
a first member for holding a base part of a first connector and a sealing plug of a second connector,
a second member for holding a sealing plug of the first connector and a base part of the second connector,
a driving device for driving the sealing plug of the first connector and the base part of the second connector, and
stopping and positioning means,
the driving device being composed of an operation shaft to be rotated by a handle, first and second gears each having no toothed portion, rotated in the opposed directions to each other through a gear train by the rotation of the operation shaft, a slider for sliding the first member, relative to the second member through a drive pin moved along a cam by the operation shaft, wherein the sealing plug of the first connector and the base part of the second connector are rotated in one direction on the second member through the first and second gears to separate from the base part of the first connector and the sealing plug of the first connector on the second member, respectively, by a first rotation of the handle of a predetermined angle in the one direction, the first member is moved with respect to the second member through the slider by a second rotation of the handle of a predetermined angle in the one direction so that the base part of the first connector is faced to the base part of the second connector, the base part of the second connector is rotated in the opposite direction on the second member through the first and second gears by a third rotation of the handle of a predetermined angle in the one direction so that the base part of the second connector and the base part of the first connector are threadedly fastened to each other, and the stopping and positioning means stops the transfer of the rotation of the first and second gears to the sealing plug of the first connector and the base part of the second connector and maintains the relative positions of the gears during the second rotation of the handle.

10. The apparatus as claimed in claim 9, wherein the stopping and positioning means comprises an intermediate gear engaging with the first and second gears, cams formed at opposite sides of the circumferential surface of the intermediate gear, first and second cams fixed to side surfaces of the first and second gears, a third cam having a notched portion fixed to a shaft of the intermediate gear, and a plunger mounted on the bearing plate at an end point of rotation of the handle so as to slidably contact with the third cam, wherein the cams of the intermediate gear are sliding on the peripheral surfaces of the first and second cams, respectively, the free rotation of the intermediate gear is stopped, and a tip end of the plunger engages with the notched portion of the cam, so that the rotation of the intermediate gear is stopped positively, even if there is a large backlash of the gear or a clearance between the cams.

11. An apparatus for attaching and detaching connectors comprising:
a first member for holding a base part of a first connector and a sealing plug of a second connector,
a second member for holding a sealing plug of the first connector and a base part of the second connector,
a driving device for driving the sealing plug of the first connector and the base part of the second connector, and
stopping and positioning means,
the driving device being composed of an operation shaft to be rotated by a handle, first and second gears each having no toothed portion, rotated in the opposed directions to each other through a gear train by the rotation of the operation shaft, a slider for sliding the first member, relative to the second member through a drive pin moved along a cam by the operation shaft, wherein the sealing plug of the first connector and the base part of the second connector are rotated in one direction on the second member through the first and second gears to separate from the sealing plug of the second connector and the base part of the first connector on the first member, respectively, by a first rotation of the handle of a predetermined angle in the one direction, the first member is moved with respect to the second member through the slider by a second rotation of the handle of a predetermined angle in the one direction so that the base part of the first connector is faced to the sealing plug of the first connector, the sealing plug of the first connector is rotated in the opposite direction on the second member through the first and second gears by a third rotation of the handle of a predetermined angle in the one direction so that the base part of the second connector and the base part of the first connector are threadedly fastened to each other, and the stopping and positioning means stops the transfer of the rotation of the first and second gears to the sealing plug of the first connector and the base part of the second connector and maintains the relative positions of the gears during the second rotation of the handle.

12. The apparatus as claimed in claim 11, wherein the stopping and positioning means comprises an intermediate gear engaging with the first and second gears, cams formed at opposite sides of the circumferential surface of the intermediate gear, first and second cams fixed to side surfaces of the first and second gears, a third cam having a notched portion fixed to a shaft of the intermediate gear, and a plunger mounted on the bearing plate at an end point of rotation of the handle so as to slidably contact with the third cam, wherein the cams of the intermediate gear are sliding on the peripheral surfaces of the first and second cams, respectively, the free rotation of the intermediate gear is stopped, and a tip end of the plunger engages with the notched portion of the cam, so that the rotation of the intermediate gear is stopped positively, even if there is a large backlash of the gear or a clearance between the cams.
